(19) United States
(12) Patent Application Publication
(10) Pub. No.: US 2010/0124263 A1
(43) Pub. Date: May 20, 2010

(54) SYSTEMS FOR DETERMINING A REFERENCE SIGNAL AT ANY LOCATION ALONG A TRANSMISSION MEDIA

(75) Inventors: G. Patrick Martin, Merritt Island, FL (US); Ronald J. Hash, Palm Bay, FL (US); Lynda Margaret Ralston, West Melbourne, FL (US)

Correspondence Address: HARRIS CORPORATION;C/O DARBY & DARBY PC, P.O. BOX 770, CHURCH STREET STATION, NEW YORK, NY, 10008-0770, US

(73) Assignee: Harris Corporation, Melbourne, FL (US)

(21) Appl. No.: 12/274,135

(22) Filed: Nov. 19, 2008

(51) Int. Cl. H04B 17/00; H04L 27/00

(52) U.S. Cl. 375/224; 375/295

(57) ABSTRACT

Systems comprising sensing devices (SD), a signal combiner (SC), signal subtractors (SS), and signal multipliers (SM). SD (116, 402, 504, 604, 620, 708a, 708b, 708c) senses at a first location along a transmission media (TM) a first signal (V_{f}) propagated over TM (100, 502, 602, 702, 1025) in a forward direction and a second signal (Vᵣ) propagated over TM in a reverse direction opposed from the forward direction. SC (406, 508, 606, 806) computes a Sum signal (S) by adding V_{f} and Vᵣ together. A first SS (408, 508, 606, 806) computes a Difference signal (D) by subtracting Vᵣ from V_{f}. A first SM (410, 510, 608a, 808a) computes a first Exponentiation signal (E_{S}) using S. A second SM (412, 512, 608b, 808b) computes a second Exponentiation signal (E_{D}) using D. A second SS (414, 514, 614, 816) subtracts E_{S} from E_{D} to obtain a reference signal (V_{ref}).

### BACKGROUND OF THE INVENTION

1. Statement of the Technical Field

The invention concerns systems implementing methods for determining a reference signal at any location along a transmission media.

2. Description of the Related Art

There are many systems and applications known to those having ordinary skill in the art that can benefit from an ability to determine a reference signal at any location along a transmission media. Such systems include, but are not limited to, radar systems and communication systems. For example, a conventional wireless communication system typically includes a system controller, a plurality of antenna controllers, and a plurality of antenna elements (e.g., a plurality of dish antennas). Each of the antenna elements is communicatively coupled to the system controller and a respective one of the antenna controllers via a cable assembly. During transmission and reception, each antenna element converts electrical signals into electromagnetic waves, and vice versa. The phases of the signals to be transmitted from and received by the antenna elements can be shifted as a result of environmental effects on hardware components of the system controller, hardware components of the antenna controllers, and the cable assemblies connecting the antenna elements to the controllers. These phase shifts typically result in the steering of the radiated main beam in the wrong direction. In order to overcome the various limitations of the communication system, it needs to implement a beamforming solution that counter acts the phase shifts resulting from environmental effects on the hardware components and cables thereof.

### SUMMARY OF THE INVENTION

Embodiments of the present invention concern systems implementing methods for determining one or more reference signals V_{ref}. The systems comprise one or more sensing devices, a first signal combiner communicatively coupled to a first one of the sensing devices (hereinafter referred to as the “first sensing device”), and a first signal subtractor communicatively coupled to the first sensing device. The first sensing device is configured for sensing, at a first location along a transmission media, a first signal propagated over the transmission media in a forward direction. The first sensing device is also configured for sensing a second signal propagated over the transmission media in a reverse direction opposed from the forward direction. The first sensing device can include, but is not limited to, a transducer, a directional coupler, and a fiber demodulator. The transmission media can include, but is not limited to, free space, a waveguide, a coaxial transmission line, an optical fiber, and an acoustic media. The second signal is a reflected version of the first signal.

The first signal combiner is configured for computing a first sum signal by adding the first and second signals together. The first signal subtractor is configured for computing a first difference signal by subtracting the second signal from the first signal. The first signal combiner and the first signal subtractor can collectively form a sum-diff hybrid circuit. The sum-diff hybrid circuit can include, but is not limited to, a 180 degree hybrid coupler.

The systems also comprise a first signal multiplier, a second signal multiplier, and a second signal subtractor. The first signal multiplier is communicatively coupled to the first signal combiner. The first signal multiplier is configured for computing a first exponentiation signal using the first sum signal. The second signal multiplier is communicatively coupled to the first signal subtractor. The second signal multiplier is configured for computing a second exponentiation signal using the first difference signal. The second signal subtractor is communicatively coupled to the first and second signal multipliers. The second signal subtractor is configured for subtracting the first exponentiation signal from the second exponentiation signal to obtain a first reference signal. The second signal subtractor can include, but is not limited to, a 180 degree hybrid coupler.

According to an aspect of the present invention, the first reference signal has a frequency equal to or different than the frequency of the first signal. If the first reference signal has a frequency different than the frequency of the first signal, then one or more post processing devices process the first reference signal to obtain an adjusted reference signal with a frequency equal to the frequency of the first signal. The post processing device can include, but is not limited to, a phase lock loop and a frequency divider. The systems can further include one or more phase and amplitude trimmers.

According to another aspect of the present invention, the systems include a reference signal generator. A second one of the sensing devices (hereinafter referred to as the “second sensing device”) is configured for sensing, at a second location different from the first location along the transmission media, the first and second signal. The reference signal generator is configured for computing a second reference signal using the first and second signals sensed at the second location. The second reference signal is the same as the first reference signal.

Embodiments of the present invention also concern communication systems. The communication systems include a sensing device and a reference signal generator communicatively coupled to the sensing device. The second sensing device is configured for sensing, at the first location along the transmission media, the first and second signals. The reference signal generator is configured for computing a sum signal by adding the first and second signals together and a difference signal by subtracting the second signal from the first signal. The reference signal generator is also configured for computing a first exponentiation signal using the first sum signal and a second exponentiation signal using the first difference signal. The reference signal generator is further configured for subtracting the first exponentiation signal from the second exponentiation signal to obtain a first reference signal.

### BRIEF DESCRIPTION OF THE DRAWINGS

Embodiments will be described with reference to the following drawing figures, in which like numerals represent like items throughout the figures, and in which:

FIG. 1 is a block diagram of a system that is useful for understanding the present invention.

FIG. 2 is a conceptual diagram of a first exemplary method (or process) for determining a reference signal that is useful for understanding the present invention.

FIG. 3 is a conceptual diagram of a second exemplary method (or process) for determining a reference signal that is useful for understanding the present invention.

FIG. 4 is a block diagram of a first exemplary embodiment of a system configured to generate a reference signal.

FIG. 5 is a block diagram of a second exemplary embodiment of a system configured to generate a reference signal.

FIG. 6 is a block diagram of a third exemplary embodiment of a system configured to generate a reference signal.

FIG. 7 is a block diagram of a fourth exemplary system configured to generate a reference signal.

FIG. 8 is a more detailed block diagram of the reference signal generator shown in FIG. 7.

FIG. 9 is a block diagram of a communication system configured to generate reference signals.

FIG. 10 is more detailed block diagram of the communication system of FIG. 9.

FIG. 11 is a schematic view of a computer system within which a set of instructions operate according to an embodiment of the present invention.

### DETAILED DESCRIPTION OF THE PREFERRED EMBODIMENTS

The present invention is described with reference to the attached figures, wherein like reference numbers are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

Embodiments of the present invention provide systems implementing methods for determining a reference signal at any location along a transmission media. The methods generally involve sensing at a first location along the transmission media a first signal (V_{f}) propagated over the transmission media in a forward direction and a second signal (Vᵣ) propagated over the transmission media in a reverse direction opposed from the forward direction. The second signal Vᵣ is a reflected version of the first signal V_{f}. The methods also involve computing a sum signal (S) by adding the first and second signals (V_{f}+Vᵣ) together and a difference signal (D) by subtracting the second signal from the first signal (Vᵣ−V_{f}). A first exponentiation signal (S²) is computed using the sum signal (S). Similarly, a second exponentiation signal (D²) is computed using the difference signal (D). The first exponentiation signal is subtracted from the second exponentiation signal (D²−S²) to obtain a reference signal (V_{ref}). Notably, the reference signal V_{ref} is defined by a mathematical equation that is not dependant on “z”, the location along the transmission media. As such, the reference signal V_{ref} can be determined at any location along the transmission media and/or at multiple different locations along the transmission media. The reference signal V_{ref} will exhibit the same phase at all locations. Notably, the reference signal(s) V_{ref} can be used in a variety of applications. For example, the reference signal(s) V_{ref} can be used to adjust a phase of transmit and/or receive signals so as to counteract the environmental effects on hardware components of a communication system.

Before describing the systems and methods of the present invention, it will be helpful in understanding exemplary environments in which the invention can be utilized. In this regard, it should be understood that the systems and methods of the present invention can be utilized in a variety of different applications where a reference signal needs to be determined at any location along a transmission media. Such applications include, but are not limited to, mobile/cellular telephone applications, military communication applications, space communication applications, phased array calibration and timing applications, radar signal distribution applications, radar calibration applications for large radar arrays, radar calibration applications for cooperative radar installations, time synchronization applications for sensors, time synchronization applications for digital systems, time synchronization applications for clocks, time synchronization applications for events, and large area (e.g., from several meters to interplanetary) metrology applications.

The word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is if, X employs A; X employs B; or X employs both A and B, then “X employs A or B” is satisfied under any of the foregoing instances.

### Systems and Methods For Determining One or More Reference Signals V_{ref}

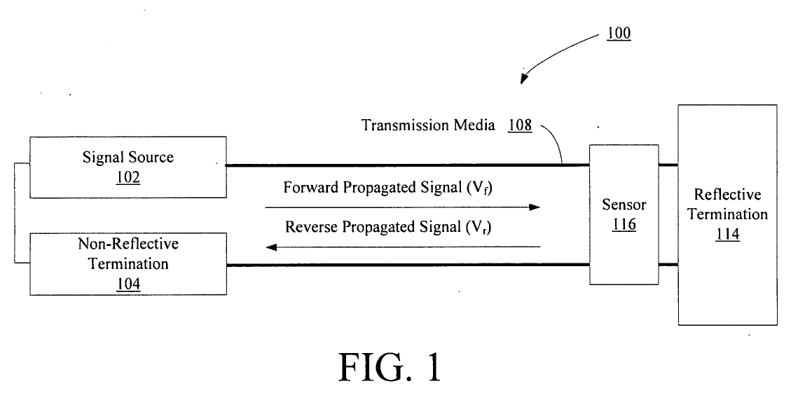

Referring now to FIG. 1, there is provided a block diagram of a system 100 that is useful for understanding the present invention. As shown in FIG. 1, the system 100 can comprise a signal source 102, a sensor 116, a reflective termination 114, and a non-reflective termination 104. Each of these components 102, 104, 114, 116 is well known to those having ordinary skill in the art, and therefore will not be described in detail herein. However it should be understood that in order to determine a reference signal V_{ref}, a forward propagated signal V_{f} and a reverse propagated signal Vᵣ need to be sensed at a location “z” along the transmission media 108. Although, the transmission media 108 is shown in FIG. 1 to include a coaxial transmission line, embodiments of the present invention are not limited in this regard. For example, the transmission media 108 can also include free space, a waveguide, an optical fiber, and an acoustic media.

In operation, the signal source 102 generally communicates a signal V_{f} to the reflective termination 114. A reflected version of the transmitted signal Vᵣ is communicated from the reflective termination 114 to the non-reflective termination 104. The sensor 116 senses the presence of the forward propagated signal V_{f} and the reverse propagated signal Vᵣ on the transmission media 108. The sensor 116 may also adjust the gain of the signals V_{f}, Vᵣ so that they have equal arbitrarily defined amplitudes “a”. This gain adjustment can involve performing Automatic Gain Control (AGC) operations which are well known to those having ordinary skill in the art. Thereafter, the sensor 116 outputs signals representing the forward propagated signal V_{f} and the reverse propagated signal Vᵣ. These output signals can subsequently be used to compute the reference signal V_{ref}.

It should be noted that the forward propagated signal V_{f} generated by the signal source 102 can be stronger (i.e., have a greater power or intensity) than the reverse propagated signal Vᵣ received at the non-reflective termination 104. As a result, coupling of the signals V_{f}, Vᵣ can occur making it difficult to distinguish the signals from each other. In order to resolve this signal coupling issue, the signal source 102 and the non-reflective termination 104 can be spaced apart (e.g., a few hundred yards). Alternatively or additionally, the reflective termination 114 can derive a frequency offset of the forward propagated signal V_{f}, adjust the frequency thereof utilizing the frequency offset, and communicating a reflected version Vᵣ of the forward propagated signal V_{f} with the adjusted frequency to the non-reflective termination 104. Embodiments of the present invention are not limited in this regard. The reflective termination 114 can implement any method for ensuring that the signals V_{f}, Vᵣ have the same or substantially similar power or intensity.

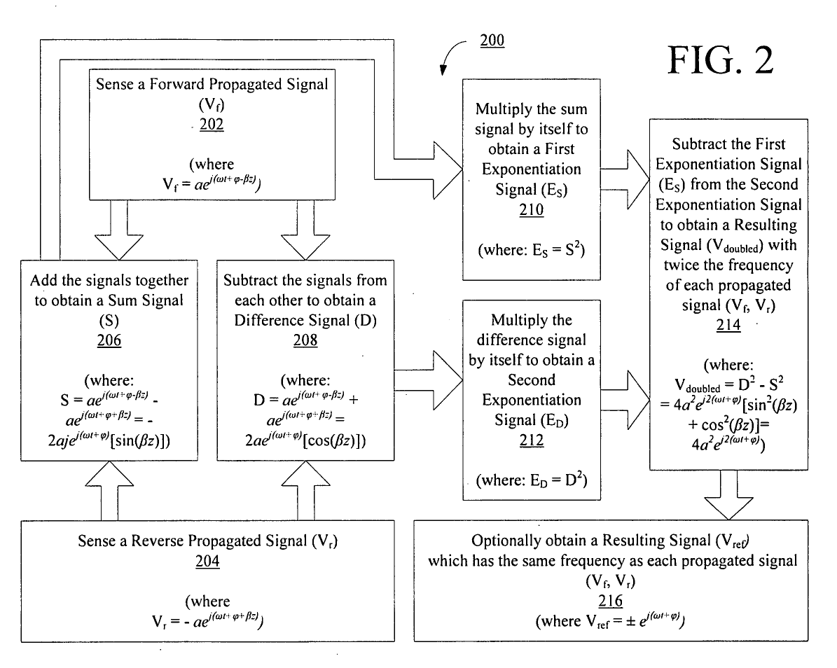

A conceptual diagram of a first exemplary process 200 for determining the reference signal V_{ref} is provided in FIG. 2. As shown in FIG. 2, the process 200 begins by (202, 204) sensing a forward propagated signal V_{f} and a reverse propagated signal Vᵣ. It should be appreciated that the sensing processes (202, 204) can involve gain adjustments as necessary so that the resulting signals have an arbitrarily defined amplitude “a”. The gain adjustments can involve performing AGC operations. The forward propagated signal V_{f} can be defined by the following mathematical equation (1). Similarly, the reverse propagated signal Vᵣ, for the exemplary case of a short circuit reflection, can be defined by the following mathematical equation (2).

V_{f}=ae^{j(ωt+φ-βz)} (1)

Vᵣ=−ae^{j(ωt+φ+βz)} (2)

where a is a signal amplitude. j the is square root of minus one (j=(−1)^{1/2}). ω is a radian frequency. φ is a phase angle. β is a wave number that is equal to 2π/λ, where λ is a wavelength. z is a location along a transmission media measured from the reflective end of the transmission media.

Thereafter, a signal combination operation 206 is performed where the signals V_{f}, Vᵣ are combined to obtain a Sum signal (S). This signal combination operation 206 generally involves adding the signals V_{f}, Vᵣ together. The signal combination operation 206 can be defined by the following mathematical equation (3).

S=ae^{j(ωt+φ-βz)}−ae^{j(ωt+φ+βz)}=−2aje^{j(ωt+φ)}[sin(βz)] (3)

As evident from mathematical equation (3), the Sum signal S is a signal that depends on the location “z” at which the sensor 116 is placed along the transmission media 108.

The process 200 also involves performing a subtraction operation 208. The subtraction operation 208 generally involves subtracting the reverse propagated signal Vᵣ from the forward propagated signal V_{f} to obtain a Difference signal (D). The subtraction operation 208 can be defined by the following mathematical equation (4).

D=ae^{j(ωt+φ-βz)}+ae^{j(ωt+φ+βz)}=2ae^{j(ωt+φ)}[cos(βz)] (4)

As evident from mathematical equation (4), the Difference signal D is a signal that depends on the location “z” at which the sensor 116 is placed along the transmission media 108.

After determining the Sum signal S and the Difference signal D, the process 200 continues with a plurality of multiplication operations 210, 212. A first one of the multiplication operations 210 generally involves multiplying the Sum signal S by itself to obtain a first Exponentiation signal E_{S}. The first multiplication operation 210 can generally be defined by the following mathematical equation (5).

E_{S}=S·S=S² (5)

where E_{S} is the first Exponentiation signal. S is the Sum signal. S² is the Sum signal S raised to the second power.

A second one of the multiplication operations 212 generally involves multiplying the Difference signal D by itself to obtain a second Exponentiation signal E_{D}. The second multiplication operation 212 can generally be defined by the following mathematical equation (6).

E_{D}=D·D=D² (6)

where E_{D} is the second Exponentiation signal. D is the Difference signal. D² is the Difference signal D raised to the second power.

Subsequent to determining the first and second Exponentiation signals, the process continues with a subtraction operation 214. The subtraction operation 214 generally involves subtracting the first Exponentiation signal E_{S} from the second Exponentiation signal E_{D}. The subtraction operation 214 can be defined by the following mathematical equation (7).

V_{doubled}=D²−S²=4a²e^{j2(ωt+φ)}[sin²(βz)+cos²(βz)]=4a²e^{j2(ωt+φ)} (7)

where V_{doubled} represents a signal obtained as a result of performing the subtraction operation 214. As evident from mathematical equation (7), the resulting signal V_{doubled} does not depend on the location “z” at which the sensor 116 is placed along the transmission media 108. As such, the signal V_{doubled} can be determined at one or more locations along a transmission media. This location “z” independence is a significant and highly desirable result.

The resulting signal V_{doubled} has twice the frequency relative to that of each propagated signal V_{f}, Vᵣ. As such, the resulting signal V_{doubled} can be further processed to increase its frequency to a desired value or to reduce its frequency to a desired value (e.g., the value of the frequency of a propagated signal V_{f}, Vᵣ). If the resulting signal V_{doubled} is further processed to increase its frequency, then the process 200 can include a multiplication operation (not shown). If the resulting signal V_{doubled} is further processed to reduce its frequency, then the process 200 can include a frequency reduction operation 216.

The optional frequency reduction operation 216 can generally involve performing a phase locked loop operation and a frequency division operation. Phase locked loop operations are well known to those having ordinary skill in the art, and therefore will not be described herein. The frequency division operation can involve dividing the frequency of the resulting signal V_{doubled} by two (2). The output signal from the frequency reduction operation is the reference signal V_{ref}. The reference signal V_{ref} can be defined by the following mathematical equation (8):

V_{ref}=±e^{j(ωt+φ)} (8)

for any line position “z”. As evident from mathematical equation (8), the reference signal V_{ref} is a signal that does not depend on the location “z” at which the sensor 116 is placed along the transmission media 108. As such, the reference signal V_{ref} can be determined at one or more locations along a transmission media. This location “z” independence is a significant and highly desirable result.

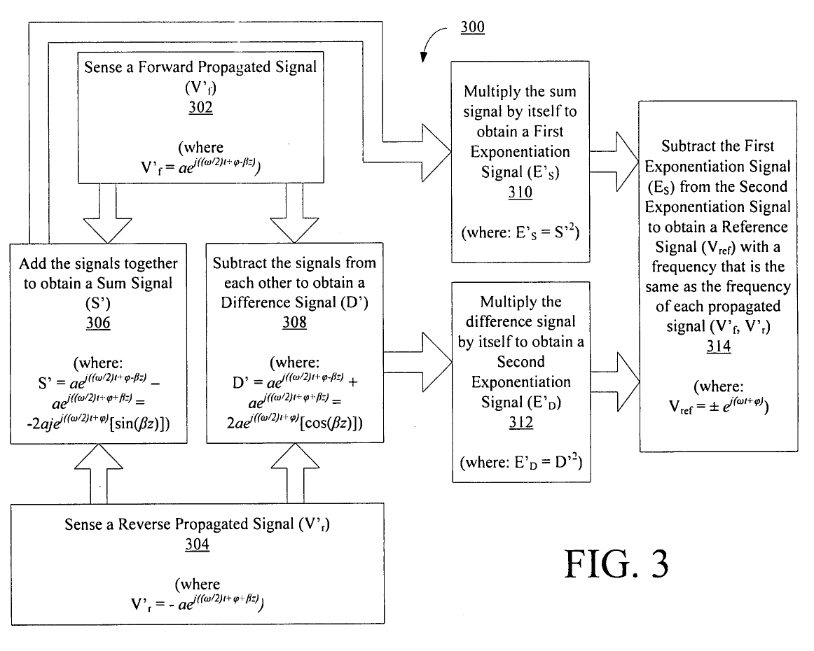

Embodiments of the present invention are not limited to the process 200 described above in relation to FIG. 2. For example, if the frequency of each propagated signal V_{f}, Vᵣ is reduced by exactly half, then the optional frequency reduction operation 216 need not be performed. A conceptual diagram of a process 300 for determining the reference signal V_{ref} absent of the frequency reduction operation 216 is provided in FIG. 3. As shown in FIG. 3, the propagated signals with half the frequency of the signals V_{f}, Vᵣ have the following designations V′_{f}, V′ᵣ, respectively.

As shown in FIG. 3, the process 300 generally involves performing sensing operations 302, 304 to sense propagated signals V′_{f}, V′ᵣ, a signal combination operation 306, subtraction operations 308, 314, and multiplication operations 310, 312. These listed operations 302, 304, . . . , 314 are the same as or substantially similar to the operations 202, 204, . . . , 214 of FIG. 2, respectively. As such, the operations 302, 304, . . . , 314 of process 300 will not be described herein.

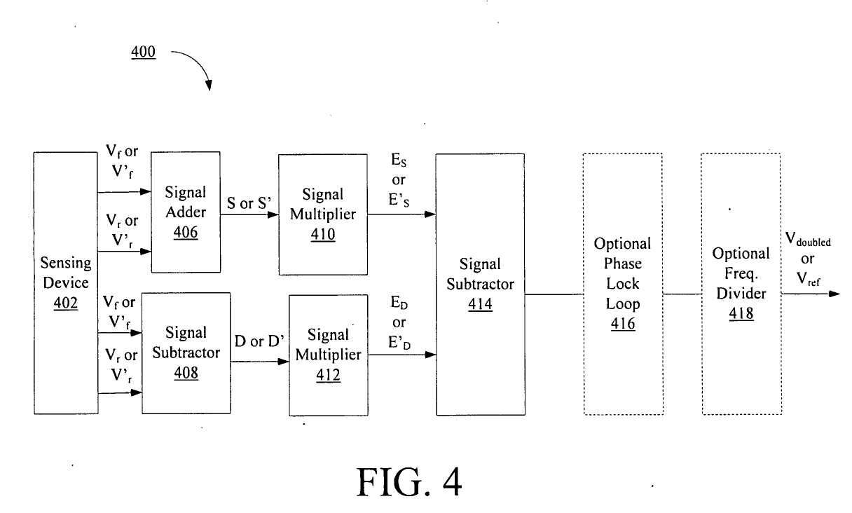

Referring now to FIG. 4, there is provided a block diagram of an exemplary system 400 implementing a method for determining a signal V_{doubled} and/or a reference signal V_{ref}. As shown in FIG. 4, the system 400 comprises a sensing device 402, a signal adder 406, signal subtractors 408, 414, and signal multipliers 410, 412. The system 400 can also comprise an optional phase lock loop 416 and an optional frequency divider 418. The sensing device 402 is generally configured for sensing the presence of a forward propagated signal V_{f} or V′_{f} and a reverse propagated signal Vᵣ or V′ᵣ on the transmission media 108. The sensing device 402 may also adjust the gain of the signals V_{f} or V′_{f}, Vᵣ or V′ᵣ so that they have equal arbitrarily defined amplitudes “a”. This gain adjustment can involve performing AGC operations. The sensing device 402 can also generate output signals representing the forward propagated signal V_{f} or V′_{f} and the reverse propagated signal Vᵣ or V′ᵣ. These output signals can subsequently be used to determine the signal V_{doubled} or the reference signal V_{ref}. As such, the sensing device 402 can further communicate the signals representing the forward propagated signal V_{f}, or V′_{f} and the reverse propagated signal Vᵣ or V′ᵣ to the following components 406, 408.

The signal adder 406 is generally configured for performing a signal combination operation 206, 306 (described above in relation to FIGS. 2 and 3) to obtain a Sum signal S or S′. The signal subtractor 408 is generally configured for performing a subtraction operation 208, 308 (described above in relation to FIGS. 2 and 3) to obtain a Difference signal D or D′. The output signals of the components 406, 408 are forwarded to the signal multipliers 410, 412. Each of the multipliers 410, 412 is configured to perform a multiplication operation 210, 212, 310, 312 (described above in relation to FIGS. 2 and 3) to obtain a respective Exponentiation signal E_{S}, E′_{S}, E_{D}, or E′_{D}. The Exponentiation signals E_{S} and E_{D} or E′_{S} and E′_{D} are then communicated from the signal multipliers 410, 412 to the signal subtractor 414. At the signal subtractor 414, a subtraction operation 214, 314 (described above in relation to FIGS. 2 and 3) is performed to obtain a signal V_{doubled} or a reference signal V_{ref}.

If the result of the subtraction operation is the signal V_{doubled}, then the signal V_{doubled} can be further processed to reduce the value of its frequency. In such a scenario, the signal V_{doubled} can be forwarded to an optional phase lock loop 416 and an optional frequency divider 418. The signal V_{doubled} can be forwarded to a multiplier (not shown). The components 416, 418 collectively act to reduce the frequency of the signal V_{doubled} to a desired value (i.e., the value of the frequency of a propagated signal V_{f}, Vᵣ). In contrast, the multiplier (not shown) can act to increase the frequency of the signal V_{doubled} to a desired value. The output of the frequency divider 418 is the reference signal V_{ref}. It should be noted that the signals V_{f}, V′_{f}, Vᵣ, V′ᵣ, V_{doubled}, and V_{ref} of FIG. 4 have the same phase.

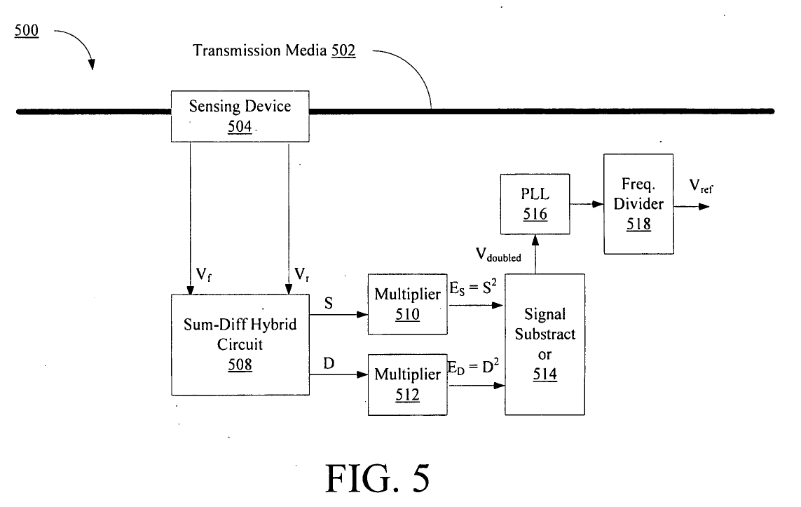

Referring now to FIG. 5, there is provided a block diagram of another exemplary embodiment of a system 500 implementing a method for determining a reference signal V_{ref}. As shown in FIG. 5, the system 500 comprises a sensing device 504 disposed along a transmission media 502. Although, the transmission media 502 is shown in FIG. 5 to include a coaxial transmission line, embodiments of the present invention are not limited in this regard. For example, the transmission media 502 can also include free space, a waveguide, and an acoustic media. The system 500 also comprises a sum-diff hybrid circuit 508, multipliers 510, 512, a signal subtractor 514, a phase lock loop (PLL) 516, and a frequency divider 518. Embodiments of the present invention are not limited to the configuration shown in FIG. 5. For example, the system 500 can be absent of the PLL 516 and the frequency divider 518. The system 500 can also include a phase locked oscillator (not shown) instead of the PLL 516 and the frequency divider 518.

The sensing device 504 is generally configured for sensing the presence of a forward propagated signal V_{f} and a reverse propagated signal Vᵣ on the transmission media 502. The sensing device 504 may also adjust the gain of the signals V_{f}, Vᵣ so that they have equal arbitrarily defined amplitudes “a”. This gain adjustment can involve performing AGC operations. The sensing device 504 can also generate output signals representing the forward propagated signal V_{f} and the reverse propagated signal Vᵣ. These output signals can subsequently be used to determine the reference signal V_{ref}. As such, the sensing device 504 can further communicate the signals representing the forward propagated signal V_{f} and the reverse propagated signal Vᵣ to the sum-diff hybrid circuit 508.

The sum-diff hybrid circuit 508 is generally configured for performing a signal combination operation 206 (described above in relation to FIG. 2) to obtain a Sum signal S and a subtraction operation 208 (described above in relation to FIG. 2) to obtain a Difference signal D. Subsequent to completing the signal combination operation 206 and the subtraction operation 208, the sum-diff hybrid circuit 508 communicates the signals S, D to the multipliers 510, 512, respectively. Each of the multipliers 510, 512 is configured to perform a multiplication operation 210, 212 (described above in relation to FIG. 2) to obtain a respective Exponentiation signal E_{S}, E_{D}. The Exponentiation signals E_{S}, E_{D} are then communicated from the multipliers 510, 512 to the signal subtractor 514. At the signal subtractor 514, a subtraction operation 214 (described above in relation to FIG. 2) is performed to obtain a signal V_{doubled}. The signal V_{doubled} is then processed by the PLL 516 and frequency divider 518 to reduce the frequency of the signal V_{doubled} to a desired value (i.e., the value of the frequency of a propagated signal V_{f}, Vᵣ). The output of the frequency divider 518 is the reference signal V_{ref}. It should be noted that the functions of the PLL 516 and the frequency divider 518 can alternatively be performed by a phase locked oscillator (not shown).

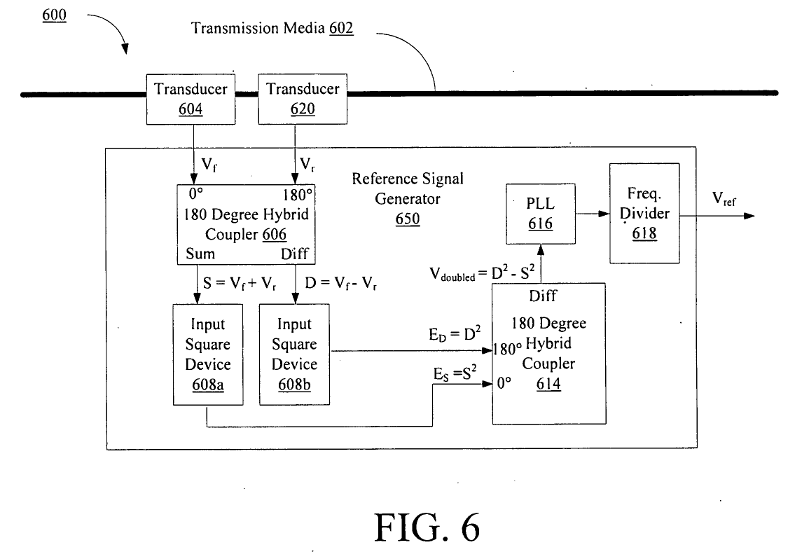

Referring now to FIG. 6, there is provided a block diagram of another exemplary embodiment of a system 600 implementing the method of FIG. 2. As shown in FIG. 6, the system 600 comprises transducers 604, 620 and a reference signal generator 650. Transducers are well known to those having ordinary skill in the art, and therefore will not be described herein. However, it should be understood that each of the transducers 604, 620 is configured to communicate a signal representing a signal V_{f}, Vᵣ propagated on the transmission media 602 to the reference signal generator 650. Although, the transmission media 602 is shown in FIG. 6 to include a coaxial transmission line, embodiments of the present invention are not limited in this regard. For example, the transmission media 602 can also include free space, a waveguide, and an acoustic media.

As also shown in FIG. 6, the reference signal generator 650 comprises 180 degree hybrid couplers 606, 614, input square devices 608a, 608b, a PLL 616, and a frequency divider 618. Embodiments of the present invention are not limited to the configuration shown in FIG. 6. For example, the reference signal generator 650 can be absent of the PLL 616 and the frequency divider 618. The reference signal generator 650 can also place the frequency divider in the feedback path of the PLL to obtain frequencies higher than the frequencies of the reference signal V_{ref}.

Hybrid couplers are well known to those having ordinary skill in the art, and therefore will not be described herein. However, it should be understood that the hybrid coupler 606 generally combines incoming signals into a first output signal. The hybrid coupler 606 also generally subtracts a first incoming signal from a second incoming signal to obtain a second output signal. In effect, the hybrid coupler 606 generates the Sum signal S and the Difference signal D using the incoming signals V_{f}, Vᵣ. The generated signals S and D are then communicated from the hybrid coupler 606 to the input square devices 608a, 608b, respectively. Each of the input square devices 608a, 608b generates a respective Exponentiation signal E_{S}, E_{D}. The Exponentiation signals E_{S}, E_{D} are communicated from the input square devices 608a, 608b to the hybrid coupler 614. The hybrid coupler 614 generally subtracts a first incoming signal from a second incoming signal to obtain a second output signal. More particularly, the hybrid coupler 614 performs a subtraction operation 214 (described above in relation to FIG. 2) to obtain a signal V_{doubled}.

Next, the signal V_{doubled} is further processed to reduce the value of its frequency. Accordingly, the signal V_{doubled} is forwarded from the hybrid coupler 614 to the PLL 616 and the frequency divider 618. The components 616, 618 collectively act to reduce the frequency of the signal V_{doubled} to a desired value (i.e., the value of the frequency of a propagated signal V_{f}, Vᵣ). The output of the frequency divider 618 is the reference signal V_{ref}.

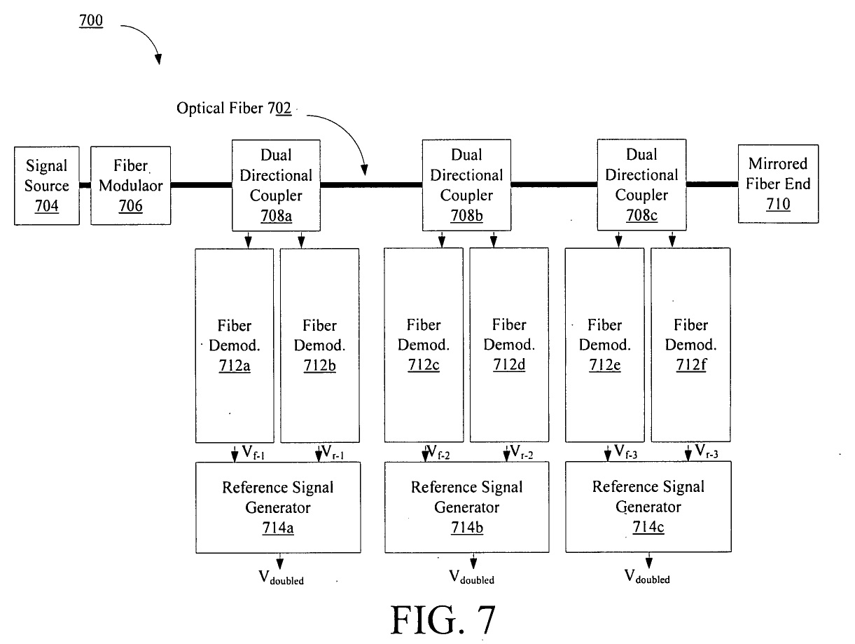

Referring now to FIG. 7, there is provided a block diagram of yet another exemplary embodiment of a system 700 implementing the method of FIG. 2. As shown in FIG. 7, the system 700 is an optical fiber based system. As such, the system 700 comprises a signal source 704, a fiber modulator 706, an optical fiber 702, and a mirrored fiber end 710. Each of these components 702, 704, 706, 710 is well known to those having ordinary skill in the art, and therefore will not be described herein.

As also shown in FIG. 7, the system 700 comprises dual directional couplers 708a, 708b, 708c, fiber demodulators 712a, 712b, 712c, 712d, 712e, 712f, and reference signal generators 714a, 714b, 714c. Dual directional couplers and fiber demodulators are well known to those having ordinary skill in the art, and therefore will not be described herein. However, it should be understood that the fiber demodulators 712a, 712b, 712c, 712d, 712e, 712f are generally configured for communicating signals V_{f-1}, Vᵣ₋₁, V_{f-2}, Vᵣ₋₂, V_{f-3}, Vᵣ₋₃ to the reference signal generators 714a, 714b, 714c, respectively. It should be noted that the signals V_{f-1}, Vᵣ₋₁, V_{f-2}, Vᵣ₋₂, V_{f-3}, Vᵣ₋₃ are unique at each of the three (3) sensor 708a, 708b, 708c locations as they vary in phase and amplitude.

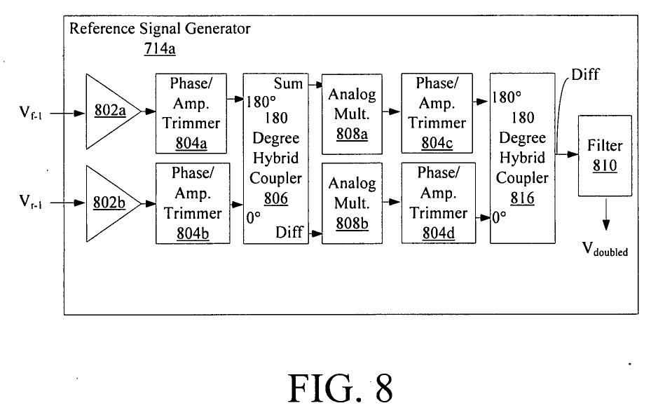

Each of the reference signal generators 714a, 714b, 714c is configured to generate a signal V_{doubled} using the received signals V_{f-1}, Vᵣ₋₁, V_{f-2}, Vᵣ₋₂, V_{f-3}, Vᵣ₋₃, respectively. More particularly, each of the reference signal generators 714a, 714b, 714c is configured for computing a Sum signal S by adding the received signals V_{f-1}, Vᵣ₋₁, V_{f-2}, Vᵣ₋₂, V_{f-3}, Vᵣ₋₃ together. Each of the reference signal generators 714a, 714b, 714c is also configured for computing a Difference signal D by subtracting a second one of the received signals Vᵣ₋₁, Vᵣ₋₂, Vᵣ₋₃ from a first one of the received signals V_{f-1}, V_{f-2}, V_{f-3}. Each of the reference signal generators 714a, 714b, 714c is also configured for computing a first Exponentiation signal E_{S} using the Sum signal S and a second Exponentiation signal E_{D} using the Difference signal D. Each of the reference signal generators 714a, 714b, 714c is further configured for subtracting the first Exponentiation signal E_{S} from the second Exponentiation signal ED to obtain the reference signal V_{doubled}. The reference signal generators 714a, 714b, 714c will be described in more detail below in relation to FIG. 8.

Referring now to FIG. 8, there is provided a more detailed block diagram of the reference signal generators 714a. Notably, the reference signal generators 714b, 714c are the same as or substantially similar to the reference signal generator 714a. As such, the following description of the reference signal generator 714a is sufficient for understanding the reference signal generators 714b and 714c.

As shown in FIG. 8, the reference signal generator 714a comprises buffers 802a, 802b, phase/amplitude trimmers 804a, 804b, 804c, 804d, 180 degree hybrid couplers 806, 816, analog multipliers 808a, 808b, and a filter 810. Buffers, phase/amplitude trimmers, and hybrid couplers are well known to those having ordinary skill in the art, and therefore will not be described herein. However, it should be understood that the hybrid coupler 806 generates signals representing the Sum signal S and the Difference signal D. The generated signals S and D are then communicated from the hybrid coupler 806 to the analog multipliers 808a, 808b, respectively. Each of the analog multipliers 808a, 808b generates a respective Exponentiation signal E_{S}, E_{D}. The Exponentiation signals E_{S}, E_{D} are communicated from the analog multipliers 808a, 808b to the hybrid coupler 816. The hybrid coupler 816 performs a subtraction operation 214 (described above in relation to FIG. 2) to obtain a signal V_{doubled}.

Next, the signal V_{doubled} is further processed to eliminate undesired spurious signals. Accordingly, the signal V_{doubled} is forwarded from the hybrid coupler 816 to the filter 810. The filter can include, but is not limited to, a bandpass filter. The filter 810 eliminates any unwanted signals generated in the analog multiplication process and leakage of the fundamental signals V_{f-1}, Vᵣ₋₁. The output of the filter 810 is the reference signal V_{doubled} having twice the frequency of signals V_{f-1}, Vᵣ₋₁. It should be noted that each of the signals V_{doubled} of FIGS. 7-8 have the same phase.

### Communication System Including A Reference Signal Generator

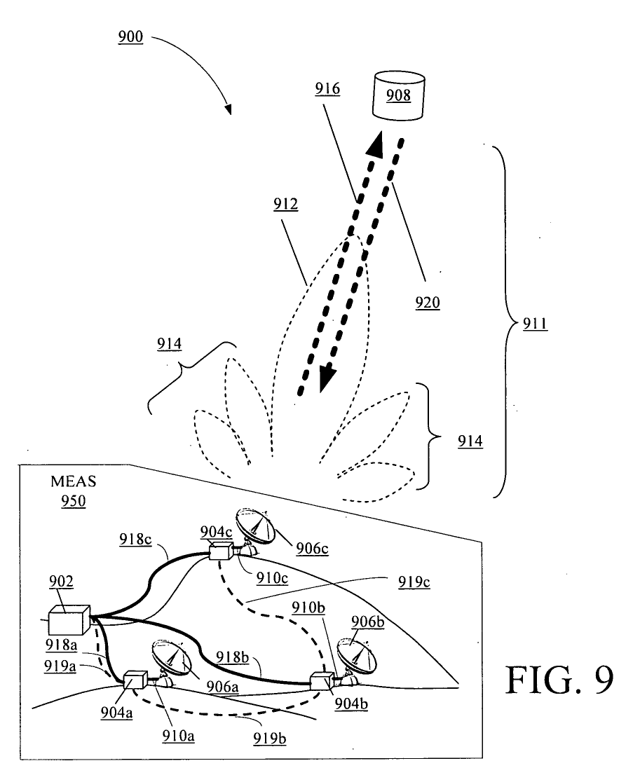

FIG. 9 shows an exemplary communication system 900 implementing the present invention. As shown in FIG. 9, the communication system 900 comprises a multi-element antenna system (MEAS) 950 for transmitting signals to and receiving signals from at least one object of interest 908 remotely located from the MEAS 950. In FIG. 9, the object of interest 908 is shown as an airborne or spaceborne object, such as an aircraft, a spacecraft, a natural or artificial satellite, or a celestial object (e.g., a planet, a moon, an asteroid, a comet, etc . . . ). However, embodiments of the present invention are not limited in this regard. The MEAS 950 can also be used for transmitting and receiving signals from objects of interest 908 that are not airborne or spaceborne but are still remotely located with respect to MEAS 950. For example, a ground-based MEAS 950 can be used to provide communications with objects of interest 908 at other ground-based or sea-based locations. The MEAS 950 can generally include an array control system (ACS) 902 for controlling the operation of multiple antenna elements 906a, 906b, 906c.

In FIG. 9, the ACS 902 is shown as controlling the operation of antenna elements 906a, 906b, 906c and associated RF equipment 904a, 904b, 904c. The antenna elements 906a, 906b, 906c provide wireless communications. For example, if the MEAS 950 is in a transmit mode, then each antenna element 906a, 906b, 906c converts electrical signals into electromagnetic waves. The radiation pattern 911 resulting from the interference of the electromagnetic waves transmitted by the different antenna elements 906a, 906b, 906c can then be adjusted to a central beam 912 in the radiation pattern 911 aimed in the direction 916 of the object of interest 908. The radiation pattern 911 of the antenna elements 906a, 906b, 906c also generates smaller side beams (or side lobes) 914 pointing in other directions with respect to the direction of the central beam 912. However, because of the relative difference in magnitude between the side beams 914 and the central beam 912, the radiation pattern 911 preferentially transmits the signal in the direction of the central beam 912. Therefore, by varying the phases and the amplitudes of the signals transmitted by each antenna element 906a, 906b, 906c, the magnitude and direction of the central beam 912 can be adjusted. If the MEAS 950 is in a receive mode, then each of the antenna elements 906a, 906b, 906c captures energy from passing waves propagated over transmission media (not shown) in the direction 920 and converts the captured energy to electrical signals. In the receive mode, the MEAS 950 can be configured to combine the electrical signals according to the radiation pattern 911 to improve reception from direction 920, as described below.

In FIG. 9, the antenna elements 906a, 906b, 906c are shown as reflector-type (e.g., a dish) antenna elements, which generally allow adjustment of azimuth (or rotation) and elevation (angle with respect to a ground plane). Therefore, in addition to adjustment of phase and amplitude of the signal transmitted by each of the antenna elements 906a, 906b, 906c, the azimuth and elevation of each antenna element 906a, 906b, 906c can also be used to further steer the central beam 912 and adjust the radiation pattern 911. However, embodiments of the present invention are not limited on this regard. The antenna elements 906a, 906b, 906c can comprise directional or omni-directional antenna elements.

Although three (3) antenna elements 906a, 906b, 906c are shown in FIG. 9, the various embodiments of the present invention are not limited in this regard. Any number of antenna elements 906a, 906b, 906c can be used without limitation. Furthermore, the spacing between the antenna elements 906a, 906b, 906c with respect to each other is not limited. Accordingly, the antenna elements 906a, 906b, 906c can be widely spaced or closely spaced. However, as the spacing between the antenna elements 906a, 906b, 906c increases, the central beam 912 generally becomes narrower and the side beams (or side lobes) 914 generally become larger. The antenna elements 906a, 906b, 906c can also be regularly spaced (not shown) with respect to one another or arbitrarily spaced (or non-linearly spaced) with respect to one another (as shown in FIG. 9) to form a three dimensional (3D) array of antenna elements. As shown in FIG. 9, the arbitrary spacing of the antenna elements 906a, 906b, 906c can include locations having different altitudes and locations having different distances between each other.

As shown in FIG. 9, each of the antenna elements 906a, 906b, 906c is communicatively coupled to a respective RF equipment 904a, 904b, 904c via a respective cable assembly 910a, 910b, 910c (collectively 910). Each of the cable assemblies 910a, 910b, 910c can have the same or different lengths. As used herein, the phrase “cable assemblies” refers to any number of cables provided or interconnecting two different components. In the various embodiments of the present invention, the cables in the cable assemblies 910a, 910b, 910c can be bundled or unbundled.

Notably, the cables 910a, 910b, 910c can delay transmit signals. In effect, the phases of the transmit signals can be shifted thereby resulting in phasing errors. As such, the communication system 900 implements a closed loop method to counteract phasing errors due to cable delay effects. The closed loop method will become more evident as the discussion progresses.

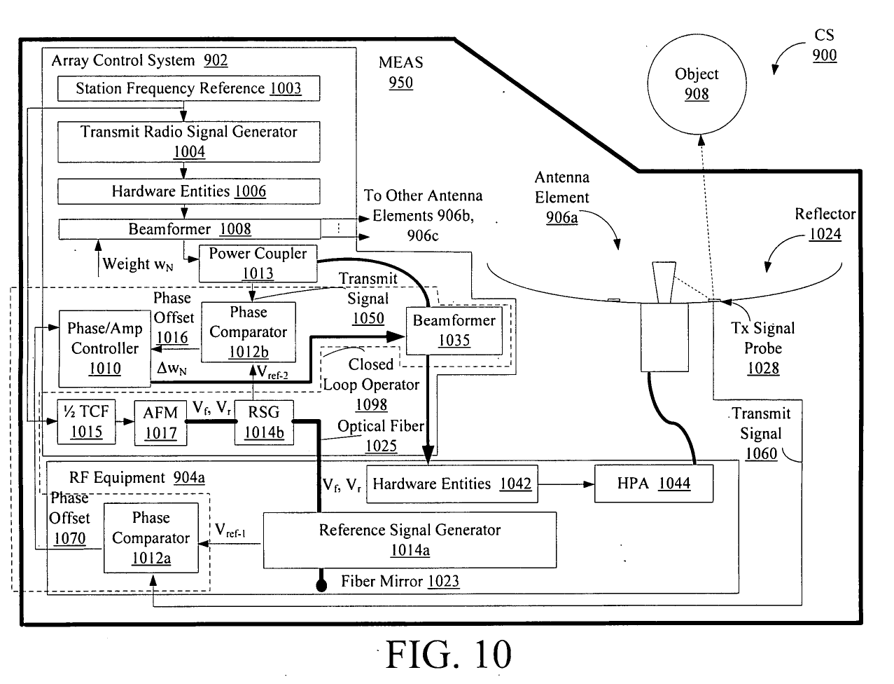

The RF equipment 904a, 904b, 904c control the antenna elements 906a, 906b, 906c, respectively. For example, for the directional antenna elements 906a, 906b, 906c shown in FIG. 9, the RF equipment 904a, 904b, 904c can be configured to control antenna motors (not shown), antenna servo motors (not shown), and antenna rotators (not shown). The RF equipment 904a, 904b, 904c can also include hardware entities for processing transmit signals and receive signals. Notably, the phases of transmit signals can be shifted as a result of environmental effects on the cabling, antenna, and/or RF equipment 904a, 904b, 904c. These phase shifts can result in the steering of the radiated central beam 912 in a direction other than the direction 916 of the object of interest 908. The RF equipment 904a, 904b, 904c will be described in more detail below in relation to FIG. 10.

As shown in FIG. 9, each of the RF equipment 904a, 904b, 904c is communicatively coupled to the ACS 902 via a respective communications link 918a, 918b, 918c. Generally, such communications links are provided via a cable assembly. However, embodiments of the present invention are not limited in this regard. In the various embodiments of the present invention, the communications links 918a, 918b, 918c can comprise wireline, optical, or wireless communication links. The cable assemblies for the communications links 918a, 918b, 918c can have the same or different lengths. Although the communications links 918a, 918b, 918c are shown to couple the RF equipment 904a, 904b, 904c to the ACS 902 in parallel, embodiments of the present invention are not limited in this regard. The RF equipment 904a, 904b, 904c can also be coupled to the ACS 902 in a series arrangement, such as that shown by communication links 919a, 919b, 919c.

Notably, the cable assemblies of the communication links 918a, 918b, 918c, 919a, 919b, 919c can delay transmit signals. In effect, the phases of the transmit signals can be shifted thereby resulting in phasing errors. Additionally, the RF electronic components 904a, 904b, 904c used in the antennas (such as power amplifiers, filters and feed horns) may also introduce phase errors. All these errors are further subject to changes in phase due to operating environment and signal levels. As such, the communication system 900 implements a closed loop method to counteract phasing errors due to imperfect phase matching. The closed loop method will become more evident as the discussion progresses.

In operation, the ACS 902 modulates signals to be transmitted by the antenna elements 906a, 906b, 906c. The ACS 902 also demodulates signals received from other antenna systems. The ACS 902 further controls beam steering. Notably, the interconnecting cables, antenna elements 906a, 906b, 906c, and RF equipment 904a, 904b, 904c can be affected by surrounding environmental conditions (e.g., heat). Such phase shifts can result in the steering of the radiated central beam 912 in a direction other than the direction 916 of the object of interest 908. As such, the communication system 900 implements a closed loop method to counteract phasing errors due to environmental effects on ACS 902. The closed loop method will become more evident as the discussion progresses. The ACS 902 will be described in more detail below in relation to FIG. 10.

In view of the forgoing, it should be appreciated that the cables 910a, 910b, 910c and the communications links 918a, 918b, 918c (or 919a, 919b, 919c) of the communication system 900 delay signals between the ACS 902 and the antenna elements 906a, 906b, 906c. In effect, the phases of the signals are shifted thereby resulting in phasing errors. Such errors are exacerbated by the spacing between the antenna elements 906a, 906b, 906c. Phasing errors further occur as a result of environmental effects on the hardware components 902, 904a, 904b, 904c of the communication system 900. The accumulated phasing errors inhibit desirable or adequate beam formation, i.e., the accumulated phasing errors can result in the steering of the radiated central beam 912 in a direction other than the direction 916 of the object of interest 908.

Accordingly, the communication system 900 is configured to adjust the phases and/or amplitudes of signals transmitted from and received at each antenna element 906a, 906b, 906c so as to counteract the errors in phasing. The phases and/or amplitudes of the transmit and receive signals can be adjusted using a reference signal V_{ref}. This phase and/amplitude adjustment function of the communication system 900 will become more evident as the discussion progresses.

Referring now to FIG. 10, there is provided a more detailed block diagram of the communication system 900 that is useful for understanding the phase and/amplitude adjustment function thereof. Notably, the antenna elements 906b, 906c and RF equipment 904b, 904c are not shown in FIG. 10 to simplify the following discussion. However, it should be understood that the antenna elements 906b, 906c are the same as or substantially similar to the antenna element 906a. Similarly, the RF equipment 904b, 904c is the same as or substantially similar to the RF equipment 906a.

As shown in FIG. 10, the ACS 902 comprises a station frequency reference 1003, a Transmit Radio Signal Generator (TRSG) 1004, hardware entities 1006, beamformers 1008, 1035, a power coupler 1013, a phase/amplitude controller 1010, a phase comparator 1012b, and a reference signal generator 1014b. Embodiments of the present invention are not limited in this regard. For example, the ACS 902 can include a set of components 1006, 1008, 1010, 1012b, 1013, 1014b, and 1035 for each antenna element 906a, 906b, 906c. As also shown in FIG. 10, the RF equipment 904a comprises hardware entities 1042, a high power amplifier (HPA) 1044, a phase comparator 1012a, and a reference signal generator 1014a. Embodiments of the present invention are not limited in this regard. For example, the RF equipment 904a can be absent of hardware entities 1042. As also shown in FIG. 10, the antenna system 950 comprises a ½ transmit carrier frequency device 1015, an analog fiber modulator 1017, an optical fiber 1025, and a fiber mirror 1023.

The TRSG 1004 of the ACS 902 can generate signals to be transmitted from the antenna elements 906a, 906b (not shown), 906c (not shown). The TRSG 1004 is communicatively coupled to the station frequency reference 1003 and the hardware entities 1006. The phrase “hardware entities”, as used herein, refers to signal processing devices, including but not limited to, filters and amplifiers. The hardware entities 1006 are communicatively coupled to the beamformer 1008.

The beamformers 1008 can be utilized to control the phases and/or the amplitudes of transmit signals. In general, the phases and/or amplitudes of the transmit signal can be used to adjust formation of the central beam 912, the side beams (or side lobes) 914, and nulls in the radiation pattern 911. Nulls correspond to directions in which destructive interference results in a transmit signal's strength that is significantly reduced with respect to the directions of the central beam 912 and the side beams 914. The beamformer 1008 combines a complex weight w_{N} with transmit signals to be provided to the RF equipment 904a, 904b (not shown), 904c (not shown).

The beamformer 1008 is communicatively coupled to power coupler 1013. The power coupler 1013 is communicatively coupled to the closed loop operator 1098. The closed loop operator 1098 will be described below. However, it should be understood that the closed loop operator 1098 is generally configured to adjust the phase and/or amplitude of transmit signals and communicate the phase and/or amplitude adjusted transmit signals to the hardware entities 1042 of the RF equipment 904a to be provided the weighted transmit signals. The hardware entities 1042 are communicatively coupled to the HPA 1044. HPAs are well known to those having ordinary skill in the art, and therefore will not be described herein. However, it should be understood that the HPA 1044 communicates signals to the antenna element 906a for transmission therefrom.

The closed loop operator 1098 is generally configured for controlling the phases and/or amplitudes of transmit signals so as to counteract phasing errors due to cable delay effects, wide antenna spacing effects, and environmental effects on hardware components 902 and 904a of the communication system 900. Accordingly, the closed loop operator 1098 includes the phase comparators 1012a, 1012b, the phase/amplitude controller 1010, and the beamformer 1035.

The phase comparator 1012a is configured to receive a transmit signal 1060 from the antenna element 906a and a reference signal V_{ref-1} from a reference signal generator 1014a. In this regard, it should be understood that the antenna element 906a has a transmit (Tx) signal probe 1028 disposed thereon for sensing the transmit signal 1060. At the phase comparator 1012a, the phase of the sensed transmit signal 1060 is compared with the phase of the reference signal V_{ref-1} to determine a phase offset 1070. The phase offset 1070 can be represented in terms of an imaginary part Q and a real part I. The phase offset 1070 is then communicated from the phase comparator 1012a to the phase/amplitude controller 1010.

The reference signal V_{ref-1} utilized by the phase comparator 1012a is generated by the reference signal generator 1014a. The reference signal generator 1014a is configured to receive sensed signals V_{f}, Vᵣ from one or more sensor devices (not shown) dispose on the optical fiber 1025 at a first location. Additionally or alternatively, the reference signal generator 1014a is configured to sense signals V_{f}, Vᵣ propagated along the optical fiber 1025. The sensed signals V_{f}, Vᵣ are used to determine the reference signal V_{ref-1}. The manner in which the reference signal V_{ref-1} is determined is described above in relation to FIGS. 1-3. The reference signal generator 1014a can be the same as or substantially similar to any one of the reference signal generator shown in FIGS. 4-8.

The phase comparator 1012b is configured to receive a transmit signal 1050 from the power coupler 1013 and a reference signal V_{ref-2} from a reference signal generator 1014b. At the phase comparator 1012b, the phase of the transmit signal 1050 is compared with the phase of the reference signal V_{ref-2} to determine a phase offset 1016. The phase offset 1016 can be represented in terms of an imaginary part Q and a real part I. The phase offset 1016 is then communicated from the phase comparator 1012b to the phase/amplitude controller 1010.

The reference signal V_{ref-2} utilized by the phase comparator 1012b is generated by the reference signal generator 1014b. The reference signal generator 1014b is configured to receive sensed signals V_{f}, Vᵣ from one or more sensor devices (not shown) disposed on the optical fiber 1025 at a second location different from the first location. Additionally or alternatively, the reference signal generator 1014b is configured to sense signals V_{f}, Vᵣ propagated along the optical fiber 1025. The sensed signals V_{f}, Vᵣ are used by the reference signal generator 1014b to determine the reference signal V_{ref-2}. The manner in which the reference signal V_{ref-2} is determined is described above in relation to FIGS. 1-3. The reference signal generator 1014b can be the same as or substantially similar to any one of the reference signal generator shown in FIGS. 4-8. The reference signal generator 1014b can also be the same as or substantially similar to the reference signal generator 1014a.

The phase/amplitude controller 1010 determines the phase and/or amplitude adjustment value Δw_{N} that is to be used by the beamformer 1035 to adjust the phase and/or amplitude of transmit signals. The phase and/or amplitude adjustment value Δw_{N} is determined using the received phase offset 1016, 1070 values received from the phase comparators 1012a, 1012b, respectively.

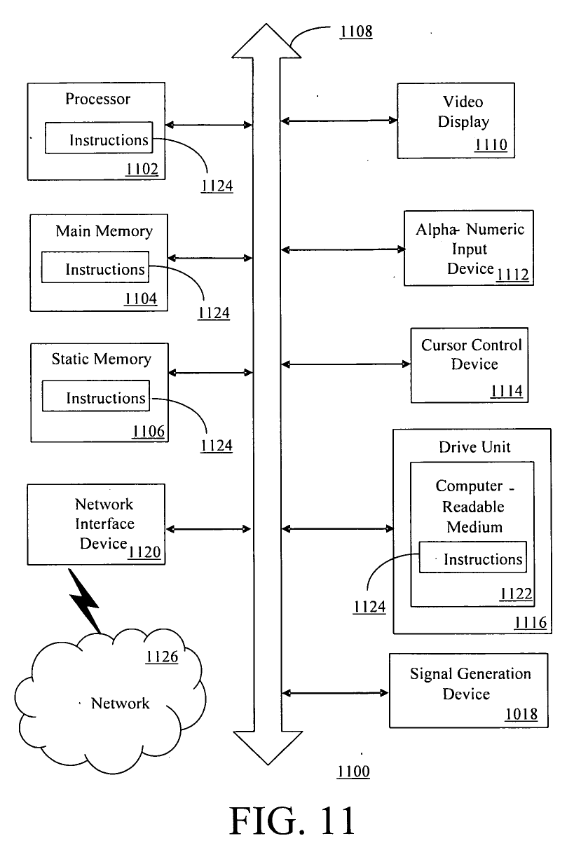

FIG. 11 is a schematic diagram of a computer system 1100 for executing a set of instructions that, when executed, can cause the computer system to perform one or more of the methodologies and procedures described above. For example, a computer system 1100 can be implemented to perform the various tasks of the systems 100, 400, 500, 600, 700, and 900. In some embodiments, the computer system 1100 operates as a single standalone device. In other embodiments, the computer system 1100 can be connected (e.g., using a network) to other computing devices to perform various tasks in a distributed fashion. In a networked deployment, the computer system 1100 can operate in the capacity of a server or a client developer machine in server-client developer network environment, or as a peer machine in a peer-to-peer (or distributed) network environment.

The computer system 1100 can comprise various types of computing systems and devices, including a server computer, a client user computer, a personal computer (PC), a tablet PC, a laptop computer, a desktop computer, a control system, a network router, switch or bridge, or any other device capable of executing a set of instructions (sequential or otherwise) that specifies actions to be taken by that device. It is to be understood that a device of the present disclosure also includes any electronic device that provides voice, video or data communication. Further, while a single computer is illustrated, the phrase “computer system” shall be understood to include any collection of computing devices that individually or jointly execute a set (or multiple sets) of instructions to perform any one or more of the methodologies discussed herein.

The computer system 1100 can include a processor 1102 (such as a central processing unit (CPU), a graphics processing unit (GPU, or both), a main memory 1104 and a static memory 1106, which communicate with each other via a bus 1108. The computer system 1100 can further include a display unit 1110, such as a video display (e.g., a liquid crystal display or LCD), a flat panel, a solid state display, or a cathode ray tube (CRT)). The computer system 1100 can include an input device 1112 (e.g., a keyboard), a cursor control device 1114 (e.g., a mouse), a disk drive unit 1116, a signal generation device 1118 (e.g., a speaker or remote control) and a network interface device 1120.

The disk drive unit 1116 can include a computer-readable storage medium 1122 on which is stored one or more sets of instructions 1124 (e.g., software code) configured to implement one or more of the methodologies, procedures, or functions described herein. The instructions 1124 can also reside, completely or at least partially, within the main memory 1104, the static memory 1106, and/or within the processor 1102 during execution thereof by the computer system 1100. The main memory 1104 and the processor 1102 also can constitute machine-readable media.

Dedicated hardware implementations including, but not limited to, application-specific integrated circuits, programmable logic arrays, and other hardware devices can likewise be constructed to implement the methods described herein. Applications that can include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the exemplary system is applicable to software, firmware, and hardware implementations.

In accordance with various embodiments of the present disclosure, the methods described herein can be stored as software programs in a computer-readable storage medium and can be configured for running on a computer processor. Furthermore, software implementations can include, but are not limited to, distributed processing, component/object distributed processing, parallel processing, virtual machine processing, which can also be constructed to implement the methods described herein.

The present disclosure contemplates a computer-readable storage medium containing instructions 1124 or that receives and executes instructions 1124 from a propagated signal so that a device connected to a network environment 1126 can send or receive voice and/or video data, and that can communicate over the network 1126 using the instructions 1124. The instructions 1124 can further be transmitted or received over a network 1126 via the network interface device 1120.

While the computer-readable storage medium 1122 is shown in an exemplary embodiment to be a single storage medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure.

The term “computer-readable medium” shall accordingly be taken to include, but not be limited to, solid-state memories such as a memory card or other package that houses one or more read-only (non-volatile) memories, random access memories, or other re-writable (volatile) memories; magneto-optical or optical medium such as a disk or tape; as well as carrier wave signals such as a signal embodying computer instructions in a transmission medium; and/or a digital file attachment to e-mail or other self-contained information archive or set of archives considered to be a distribution medium equivalent to a tangible storage medium. Accordingly, the disclosure is considered to include any one or more of a computer-readable medium or a distribution medium, as listed herein and to include recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

In light of the forgoing description of the invention, it should be recognized that the present invention can be realized in hardware, software, or a combination of hardware and software. A method for determining a reference signal V_{ref} according to the present invention can be realized in a centralized fashion in one processing system, or in a distributed fashion where different elements are spread across several interconnected processing systems. Any kind of computer system, or other apparatus adapted for carrying out the methods described herein, is suited. A typical combination of hardware and software could be a general purpose computer processor, with a computer program that, when being loaded and executed, controls the computer processor such that it carries out the methods described herein. Of course, an application specific integrated circuit (ASIC), and/or a field programmable gate array (FPGA) could also be used to achieve a similar result.

Applicants present certain theoretical aspects above that are believed to be accurate that appear to explain observations made regarding embodiments of the present invention. However, embodiments of the present invention may be practiced without the theoretical aspects presented. Moreover, the theoretical aspects are presented with the understanding that Applicants do not seek to be bound by the theory presented.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others having ordinary skill in the art upon the reading and understanding of this specification and the annexed drawings. In addition, while a particular feature of the present invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

We claim:

1. A system, comprising:
at least one first sensing device configured for sensing at a first location along a transmission media a first signal propagated over the transmission media in a forward direction and a second signal propagated over the transmission media in a reverse direction opposed from the forward direction, the second signal being a reflected version of the first signal;
a first signal combiner communicatively coupled to the first sensing device and configured for computing a first sum signal by adding the first and second signals together;
a first signal subtractor communicatively coupled to the first sensing device and configured for computing a first difference signal by subtracting the second signal from the first signal;
a first signal multiplier communicatively coupled to the first signal combiner and configured for computing a first exponentiation signal using the first sum signal;
a second signal multiplier communicatively coupled to the first signal subtractor and configured for computing a second exponentiation signal using the first difference signal; and
a second signal subtractor communicatively coupled to the first and second signal multipliers and configured for subtracting the first exponentiation signal from the second exponentiation signal to obtain a first reference signal.

2. The system according to claim 1, wherein the first reference signal has a first frequency equal to a second frequency of the first signal.

3. The system according to claim 1, wherein the first reference signal has a first frequency different than a second frequency of the first signal.

4. The system according to claim 3, further comprising at least one post processing device configured for processing the first reference signal to obtain an adjusted reference signal with a third frequency equal to the second frequency of the first signal.

5. The system according to claim 4, wherein the at least one post processing device comprises at least one device selected from the group consisting of a phase lock loop, a frequency divider, a phase locked oscillator.

6. The system according to claim 1, wherein the transmission media is selected from the group consisting of free space, a waveguide, a coaxial transmission line, an optical fiber, and an acoustic media.

7. The system according to claim 1, wherein the first sensing device is selected from the group consisting of a transducer and a directional coupler.

8. The system according to claim 1, wherein the first sensing device comprises a directional coupler and a fiber demodulator.

9. The system according to claim 1, wherein the first signal combiner and the first signal subtractor collectively comprise a sum-diff hybrid circuit.

10. The system according to claim 9, wherein the sum-diff hybrid circuit is a 180 degree hybrid coupler.

11. The system according to claim 1, wherein the second signal subtractor is a 180 degree hybrid coupler.

12. The system according to claim 1, further comprising at least one phase and amplitude trimmer.

13. The system according to claim 1, further comprising
at least one second sensing device configured for sensing at a second location different from the first location along the transmission media the first and second signal; and
a reference signal generator configured for computing a second reference signal using the first and second signals sensed at the second location;
wherein the second reference signal is the same as the first reference signal.

14. The system according to claim 13, wherein the reference signal generator is further configured for computing a second sum signal by adding the first and second signals sensed at the second location together, computing a second difference signal by subtracting the second signal sensed at the second location from the first signal sensed at the second location, computing a third exponentiation signal using the second sum signal, computing a fourth exponentiation signal using the second difference signal, and subtracting the third exponentiation signal from the fourth exponentiation signal to obtain the second reference signal.

15. A system, comprising:
at least one first sensing device configured for sensing at a first location along a transmission media a first signal propagated over the transmission media in a forward direction and a second signal propagated over the transmission media in a reverse direction opposed from the forward direction, the second signal being a reflected version of the first signal;
a first hybrid coupler communicatively coupled to the first sensing device and configured for computing a first sum signal by adding the first and second signals together and a first difference signal by subtracting the second signal from the first signal;
a first signal multiplier communicatively coupled to the first hybrid coupler and configured for computing a first exponentiation signal using the first sum signal;
a second signal multiplier communicatively coupled to the first hybrid coupler and configured for computing a second exponentiation signal using the first difference signal; and
a second hybrid coupler communicatively coupled to the first and second signal multipliers and configured for subtracting the first exponentiation signal from the second exponentiation signal to obtain a first reference signal.

16. The system according to claim 15, wherein the first sensing device is selected from the group consisting of a transducer and a directional coupler.

17. The system according to claim 15, further comprising at least one phase and amplitude trimmer.

18. A communication system, comprising:
at least one first sensing device configured for sensing at a first location along a transmission media a first signal propagated over the transmission media in a forward direction and a second signal propagated over the transmission media in a reverse direction opposed from the forward direction, the second signal being a reflected version of the first signal; and
at least one reference signal generator communicatively coupled to the first sensing device and configured for computing a first sum signal by adding the first and second signals together, computing a first difference signal by subtracting the second signal from the first signal, computing a first exponentiation signal using the first sum signal, computing a second exponentiation signal using the first difference signal, and subtracting the first exponentiation signal from the second exponentiation signal to obtain a reference signal.

19. The communication system according to claim 18, wherein the transmission media is selected from the group consisting of free space, a waveguide, a coaxial transmission line, an optical fiber, and an acoustic media.

20. The communication system according to claim 18, further comprising a phase comparator for determining a phase offset by comparing a phase of a transmit signal to a phase of the reference signal.
